(19) United States
(12) Patent Application Publication
(10) Pub. No.: US 2013/0276573 A1
(43) Pub. Date: Oct. 24, 2013

(54) METHOD FOR PRODUCING A STEERING WHEEL AND COVERING FOR COVERING A STEERING WHEEL RIM OF A STEERING WHEEL

(71) Applicants: Daniel Henning, Aschaffenburg (DE); Jürgen Kolb, Aschaffenburg (DE); Martin Sauer, Hosbach (DE)

(72) Inventors: Daniel Henning, Aschaffenburg (DE); Jürgen Kolb, Aschaffenburg (DE); Martin Sauer, Hosbach (DE)

(21) Appl. No.: 13/994,620

(22) PCT Filed: Dec. 13, 2011
(86) PCT No.: PCT/EP2011/072594

§ 371 Date: Jun. 27, 2013

(30) Foreign Application Priority Data
Dec. 17, 2010 (DE) 10 2010 063 440.9

(51) Int. Cl. B32B 37/12; B62D 1/06

(52) U.S. Cl. CPC B32B 37/12; B62D 1/06
USPC 74/558; 156/93

(57) ABSTRACT

A method for producing a steering wheel for a vehicle is provided with the method including the following steps: providing a steering wheel rim, providing a first and a second blank, in particular made of leather, for producing a covering of the steering wheel rim which covering is visible after the steering wheel is completed; producing the covering by connecting a first edge section of the first blank to a first edge section of the second blank via a seam; and finally covering the steering wheel rim with the covering in such a manner that the seam, which connects the first and the second blank to each other, continues essentially along an inner circumference of the steering wheel rim and is visible from the outside in the completed steering wheel.

The invention relates to a method for producing a steering wheel according to claim 1 and a covering for covering a steering wheel rim of a steering wheel according to claim 15.

It is known from the prior art when producing the steering wheel to encompass the foaming of a steering wheel skeleton with a covering visible from the outside, in particular made of leather, in order to provide the steering wheel with a preferably high valued appearance. Producing such a covering requires, however, a large amount of manual work and is thus accompanied by relatively high costs.

The problem to be solved by the invention is to provide a method and a covering for producing a steering wheel with which a qualitatively high valued steering wheel can be produced at preferably low costs.

This problem is being solved by the method with the features of claim 1 and by the covering with the features of claim 15. Modifications of the invention are provided in the claims.

Accordingly, a method for producing a steering wheel for a vehicle is provided comprising the steps:
a) providing a steering wheel rim;
b) providing a first and second blank for producing a covering of the steering wheel rim which covering is visible after the steering wheel is completed;
c) producing the covering by sewing a first edge section of the first blank with a first edge section of the second blank; and
d) finally covering the steering wheel rim with the covering produced according to step c) such that the seam which connects the first and the second blank to each other continues essentially along the circumference of the steering wheel rim and is visible from the outside.

The steering wheel produced in this manner comprises thus a seam which is visible from the outside, i.e. in particular recognizable by a vehicle occupant, which in particular, when using leather blanks provides a specifically high valued appearance of the steering wheel. Since the sewing of the first edge section of the first blank with the first edge section of the second blank occurs before attaching the covering to the steering wheel rim the sewing can be carried out by a machine, for instance by means of a conventional industrial sewing machine. A particularly decorative (for instance zig-zag-like) seam course can be produced in particular in a simple manner. A “blank” is a flat material layer continuing along a main extension plane which does not have to be made necessarily of leather, but can also for instance be made of a plastic (in particular artificial leather).

The sewing according to step c) can be carried out such that an edge of the first edge section of the first blank is brought into abutment with an edge of the first edge section of the second blank such that the first and the second edge section essentially do not overlap, i.e., the first edge sections are arranged by abutting against each other. It is, however, also conceivable that the first edge sections are not placed edge by edge before sewing, but that they overlap each other.

It is also pointed out that the formulation according to which the seam “continues essentially along the circumference of the steering wheel rim” does not necessarily mean that the seam extends along the complete circumference of the steering wheel rim. It is rather also conceivable that the seam continues only along a part of the circumference of the steering wheel rim.

Furthermore, a second edge section of the first blank can be connected to a second edge section of the second blank after the covering according to step d) wherein the second edge sections (relative to the flatly stretched out status of the blanks) continue to each other in particular with a distance. The seam and the connecting area, in which the second edge sections are connected to each other, continue in the completed steering wheel in particular along a circumference of the steering wheel rim.

The two blanks are for instance in each case designed essentially strip-like, wherein the first edge sections for instance at least partially and at least approximately continue in a straight line. The respective second edge sections continue here for instance also in a straight line and in particular essentially parallel to the first edge sections. However, it is also in particular possible that the first and second edge sections of the two blanks do not continue in a straight line (but for instance at least sectionally curved) in order to allow for a preferably crease-free covering of the steering wheel rim. Furthermore, the first and the second edge sections of the blanks do not have to continue parallel to each other. A covering with a spatial structure adapted to the geometry of the steering wheel rim is obtained in particular after connecting the two blanks via the seam.

According to a further embodiment of the invention the steering wheel rim comprises a groove into which both of the two edge sections are to be inserted. The first and the second blank comprise in each case for this reason an access, i.e. after covering the steering wheel rim (in particular along the circumference of the steering rim continuing, flap-like) second edge section sticks out, respectively, which is in each case inserted into the groove (for instance pressed).

Furthermore, the steering wheel rim can comprise a steering wheel skeleton and a foaming encompassing the steering wheel rim skeleton, wherein the groove is formed in the foaming. The groove continues in particular radially relative to the steering wheel rim into the foaming and comprises for instance an at least approximately rectangular (radial) cross section. It is hereby conceivable that the groove extends along the complete circumference of the steering wheel rim (whereby the “circumference” relates here to the circumference of the steering wheel rim in a top view). It is however also possible that the groove (and thus also the second edge section of the first and the second blank) continues only over a part of the circumference of the steering wheel rim.

It is to be pointed out that the term “connecting” both second edge sections can also be understood such that they are only inserted into the groove. The groove is hereby provided such that both second edge sections are clamped in the groove by pressing at each other without that they are connected by means of additional fixing means. It is of course also possible, that both second edge sections are not only clamped against each other, but are fixed to each other by fixing means.

The arrangement of the second edge sections in a groove is also not necessarily required. It is also conceivable that the second edge sections of the first and the second blank abut more or less flatly against the steering wheel rim and are connected to each other, for instance firmly bonded or by sewing or clamping. Hereby, it is conceivable that also the second edge sections abut against each other bluntly before connecting or are arranged by overlapping each other. In case of an overlapping arrangement it is also possible that at least one of both second edge sections is sharpened that means the respective second edge section is formed wedge-shaped towards the edge of the edge section in order to preferably avoid a bulged course of the overlapping area.

According to another variant of the invention, the covering produced according to step c) from the first and the second blank is placed over the foaming of the steering wheel rim such that it abuts with an inner side against a surface of the foaming. The covering follows in particular in the area of the seam, via which the first edge sections of the blanks are connected to each other, the surface of the foaming, whereby no groove is present in the foaming in the area of the seam, but the seam and both first edge sections abut against a deepening free section of the surface of the foaming.

It is also conceivable that the covering is connected at least partially firmly bonded to the foaming. A side of the covering, i.e. of both blanks connected to each other, is hereby for instance provided with a glue and the covering is placed with this side provided with glue over the steering wheel rim. The glue is for instance a glue which can be activated by thermal treatment such that the covering of the steering wheel rim does not have to occur necessarily immediately after applying the glue onto the covering. It has to be pointed out that the gluing of the covering onto the steering wheel rim is of course only optional. It is also conceivable that the covering as mentioned above is only placed over the steering wheel rim.

In order to position the covering on the steering wheel rim (that means in particular on a foaming of a steering wheel rim skeleton) a correspondingly designed positioning device in particular is used, for instance a rotation symmetrical tool, which comprises an angular circumferential indentation, with which the covering can be pressed onto the steering wheel rim.

It is however also possible that the arrangement of the covering on the steering wheel rim can be done at least partially manual. It is also conceivable that a roll tool is used in order to place the covering (automatically or at least semi-automatically) over the steering wheel rim and to press thereon. If the second edge sections of the covering have to be inserted into a groove of the steering wheel rim, a wedge like designed tool can be used for this such that in particular also an automatic insertion of the second edge sections into the groove is possible. In case that both second edge sections are however not to be connected to each other in a groove but rest flatly against the steering wheel rim, the connecting can be carried out with the roll tool as mentioned already above.

It is furthermore conceivable that the first or the second blank consists of multiple parts, respectively, which are connected (in particular sewed) to each other, for instance, before producing the covering. For example, such parts of the blanks comprise in the area of a spoke of the steering wheel a (e.g. at least approximately radially continuing) edge section, respectively, whereby the edge sections are connected to each other. It is however also of course possible that the first and the second blank are designed in one piece, respectively, that means consists in each case of one continuous material layer.

According to a further embodiment of the invention the seam, which connects the first and the second blank to each other, continues after the covering according to step c) along an inner circumference of the steering wheel rim. Thus, the seam faces in particular a hub of the steering wheel.

The two edge sections connected to each other can continue in the steering wheel when completed such that they are arranged by facing away from a driver in respect to the status of the steering wheel when assembled in the vehicle, i.e. are not recognized by a driver on the driver seat. The second edge sections connected to each other in particular continue such that they continue along a lower side of the steering wheel, which faces away from the driver.

For example, the seam, which connects the first and the second blank to each other, and the second edge sections connected to each other—if looked at in the radial cross section through the covered steering wheel rim—are arranged in particular at least approximately in an angle of about 90°. The seam, which connects the first and the second blank to each other, is arranged in particular along an inner circumference while the second edge sections connected to each other continue along a lower side (facing away from the driver) of the steering wheel rim.

It is also conceivable that before covering the steering wheel rim, a first and a second end section of the first and/or second blank are connected to each other, respectively, such that a angular structure is obtained in each case, which is then placed around the outer surface of the steering wheel rim. It is however also possible that the first and the second end section of the first and/or the second blank are only connected to each other after placing the covering around the steering wheel rim.

The invention relates also to a covering for covering a steering wheel rim of a steering wheel for a vehicle comprising:
a first and a second blank, wherein a first edge section of the first blank is connected to a first edge section of the second blank via a seam such that the covering obtains a spatial design and the seam continues such that it continues after arranging the covering on the steering wheel rim along an inner circumference of the steering wheel rim, wherein
the first and the second blank comprise a second circumferential free edge section, respectively, which continuous after covering the steering wheel rim with the covering by facing away from the driver of the vehicle in respect to the status of the steering wheel when assembled in the vehicle.

The fact that the second edge sections of the blanks are “freely” designed means that they are not connected to each other. The covering is produced, e.g. as above described in respect to the method according to the invention and is to be arranged on a steering wheel rim in particular such that the seam rests against a surface section of a foaming, which encompasses the steering wheel rim, which is free of deepening such that the seam is visible from the outside in the steering wheel when completely produced. Only after arranging the covering on the steering wheel rim, the connecting of the second edge sections is carried out.

The foaming in the area of the seam is curved in particular according to the type of a torus and thus does not comprise any deepening there. The seam is not arranged in particular in a groove of the foaming.

The invention is explained in the following in more detail by means of embodiments with reference to the Figures. It shows:

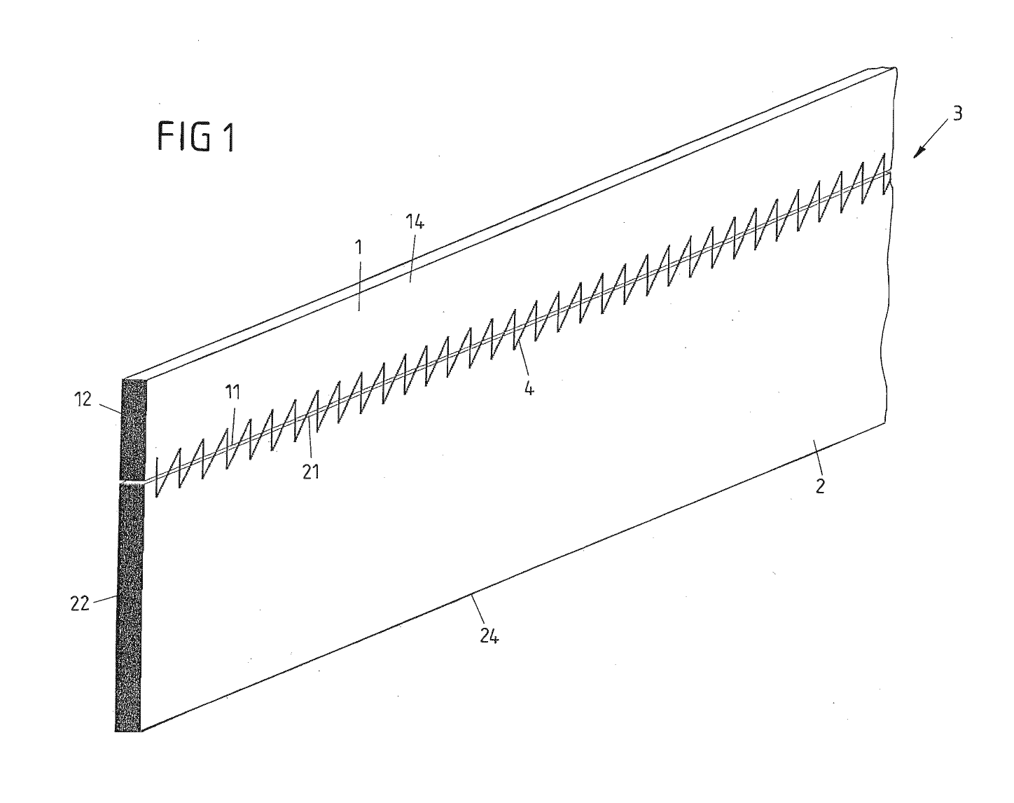

FIG. 1 a steering wheel rim covering before arranging the same on a steering wheel rim;

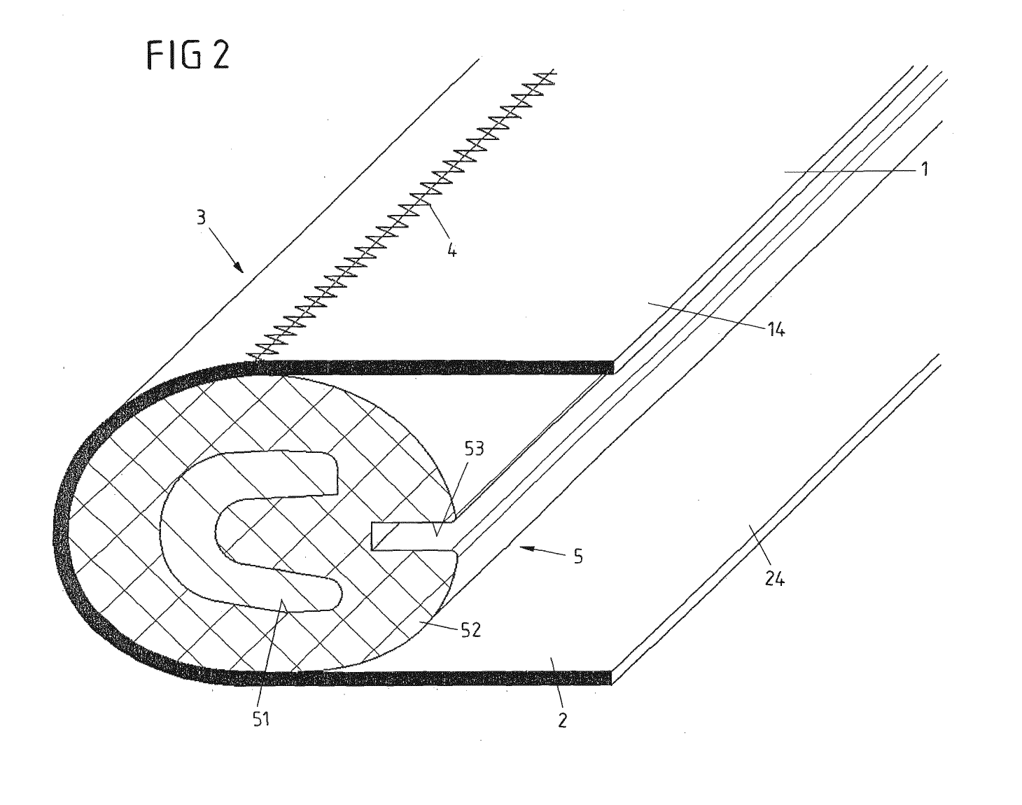

FIG. 2 the covering of FIG. 1 while arranging the same on a steering wheel rim;

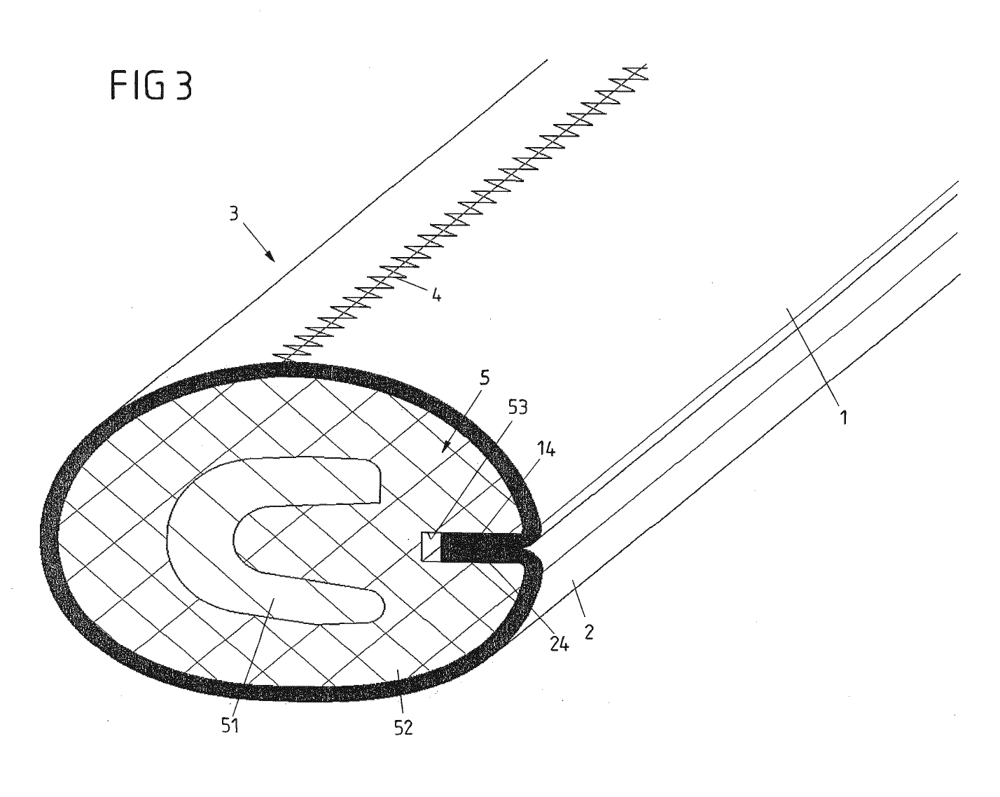

FIG. 3 the steering wheel rim of FIG. 2 in a completed status;

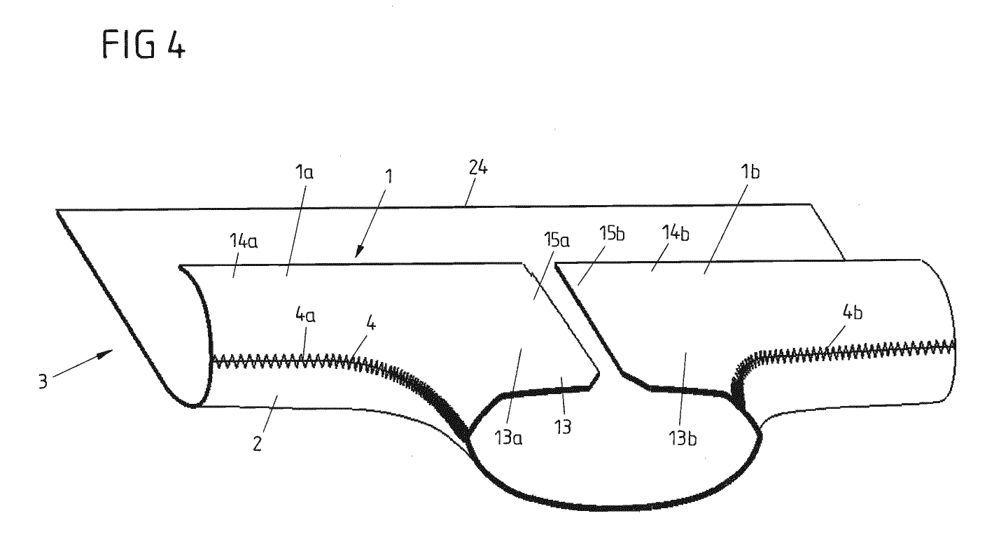

FIG. 4 a further variant of a covering of a steering wheel rim;

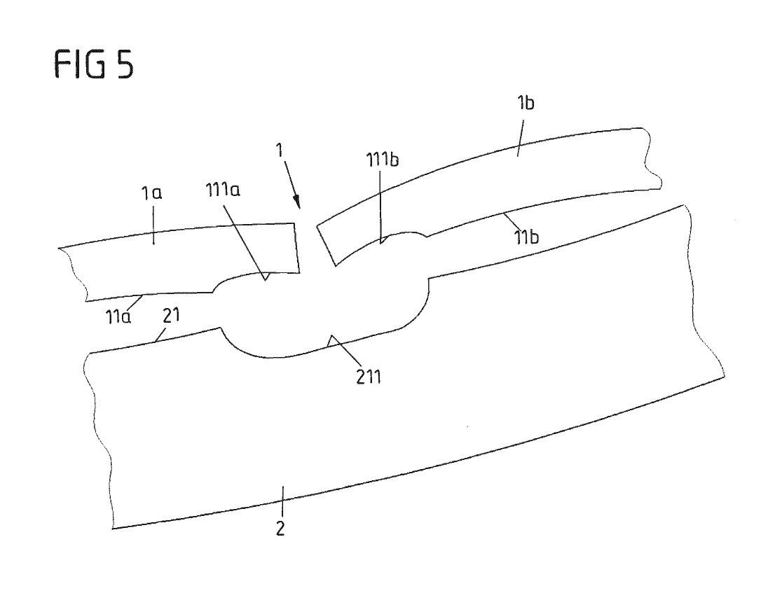

FIG. 5 an area of a first or a second blank for a steering wheel covering; and

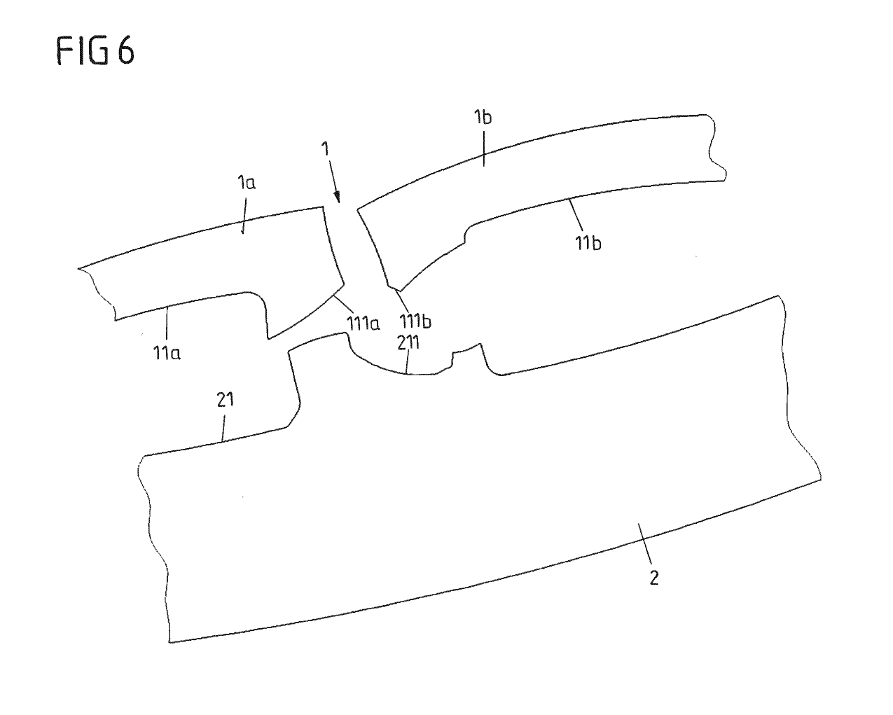

FIG. 6 also an area of a first or a second blank.

FIGS. 1 to 3 illustrate consecutive method steps of an embodiment of the method according to the invention. FIG. 1 shows a sub-area of a first blank in form of a first leather blank 1 and a sub-area of a second blank in form of a second leather blank 2 of a covering 3 produced for the steering wheel rim (not shown) of a steering wheel.

Blank 1 comprises a longitudinal first edge section 11, which extends along an also longitudinal first edge section 21 of a second blank 2 and, for instance, rests against the same. More particular, the edge sections 11, 21 of the blanks rest against each other with their respective edges facing each other (i.e. front sides of the respective edge section, which extend vertical to the main extension plain of the respective blank). The first edge sections 11, 21 are connected to each other via the sewing seam 4.

Both leather blanks 1, 2 are designed such that they can be placed over the circumference of a steering wheel rim around the same. Hereby the one leather blank (blank 2) comprises in a flatly spread status a larger width (i.e. extension vertical to the main extension direction of the blank or to the course of the seam 4) than the first leather blank 1. Thus, the leather blank 2 will extend around a larger circumference section of the steering wheel rim than the first leather blank 1. The second leather blank 2, for instance, covers about two-third up to three quarter of the outer circumference of the steering wheel rim; compare FIG. 3. The “circumference” is here to be understood as a cross-section circumference.

The leather blanks 1, 2 comprise furthermore in each case a second edge section 14, 24 which extends (at a flatly spread blank) in each case, for instance, mainly parallel to the respective first edge section 11, 21. It is, however, also conceivable that the first and the second edge sections do not continue parallel to each other. The first and/or the second edge section continue, for instance, not in a straight line, but are at least sectional curved (compare FIGS. 5 and 6).

After covering (leathering) of the steering wheel rim with the covering, said covering is closed by connecting the second edge sections 14, 24 as will be explained later.

Furthermore, both leather blanks 1, 2 can be closed to a ring before or after arranging on a steering wheel rim (however, after they have been connected to each other via the seam 4). For this purpose, free ends are connected in each case to each other of which FIG. 1 shows in each case only one, namely the end 12 of the first leather blank and the end 22 of the second leather blank.

FIG. 2 shows how the covering 3 of FIG. 1 is placed around a steering wheel rim 5 of a steering wheel after both leather blanks 1, 2 have been connected to each other (in particular by a machine) via the seam 4. FIG. 2 shows a radial section of the steering wheel rim and through the covering 3, accordingly.

The steering wheel rim 5 comprises a steering wheel rim skeleton 51 which is encompassed by a foaming 52. A recess in form of a groove 53 is located in the foaming 52, wherein said groove continues along at least one part of an inner circumference of the steering wheel rim 5, i.e., about the centre point of a steering wheel rim. The seam 4 is arranged such that it points in the completed steering wheel to a steering wheel hub (that means at least approximately to a centre point of the steering wheel).

The groove 53 comprises an approximately rectangular geometry in the radial cross section of the steering wheel rim and is arranged—in respect to the status of the steering wheel arranged in the vehicle—such that it points away from the driver of the vehicle in the completed steering wheel assembled in the vehicle, wherein the seam 4 and the groove 53, if looked at in the cross section, are arranged to each other in about a 90° angle that means in the illustration of FIG. 2 the seam in the cross section is located in the cross section at about “12 o'clock” while the groove is arranged at about “3 o'clock”. The side of the steering wheel rim facing downwards in the illustration of FIG. 2 will point away from the driver in the assembled status of the steering wheel.

The seam 4 is arranged such that it is visible from the outside in the completed steering wheel, wherein the first edge sections of the leather blanks 1, 2 connected to each other via the seam 4 rest essentially flatly against an outer side of the foaming 52, i.e. the seam 4 is not hidden in a groove but positioned in a noticeably location in order to emphasize the leather character of the covering 3.

The width of the leather blanks 1, 2 is dimensioned such that they have a certain excess, respectively, i.e. they are in each case wider than the surface section of the foaming 52 to be covered by the respective blanks. The excess of the leather blanks 1, 2 corresponds in particular at least approximately to the depth of the groove 53 or is smaller than the depth of the groove 53. The leather blanks 1, 2 can be inserted into the groove 53 due to their excess, as illustrated in FIG. 3.

It is also conceivable that both second edge sections 14, 24 are solely connected to each other by pushing into the groove 53 such that surface sections of the outer side of the respective blank rest against each other. It is however also conceivable that the second edge sections 14, 24 are connected to each other before or after their arrangement in the groove via fixing means, for instance are glued or sewed to each other. It is also possible that an inner side of the covering 3, that means a side which faces the steering wheel rim after covering, is provided with glue and is glued to the outer side of the foaming 52 such that the edge sections 14, 24 are also glued to the side walls of the groove 53.

FIG. 4 relates to a further example for a covering which can be used in the method according to the invention for covering a steering wheel rim in analogy to FIGS. 1 to 3. Here also a first leather blank 1 is connected to a second leather blank 2 via a seam 4. The first leather blank 1 comprises however multiple parts 1a, 1b which form in each case a subsection 13a, 13b of an extension 13, which shall extend over a part of a steering wheel spoke (not shown).

Accordingly, the seam 4 is not designed continuously but comprises a first section 4a, which connects the first blank part 1a to the second blank 2 and a second section 4b, which connects the second blank part 1b to the second blank 2. After connecting the blank parts 1a, 1b to the second leather blank 2 an edge section 15a of the first part 1a and an edge section 15b of the second part 1b are facing each other at least approximately and continue in the completed steering wheel essentially vertical to the circumference of the steering wheel rim. Both edge sections are connected to each other or only to the steering wheel rim via fixing means (for instance a seam or by gluing).

Due to the multi-piece design of the first leather blank 1 the second edge section 14, which shall be pushed into a groove of the steering wheel rim (not shown) in analogy to FIGS. 1 to 3, is accordingly also divided into sections 14a, 14b. Furthermore, the first leather blank 1 can comprise still further sub-pieces, which are not illustrated in FIG. 4. It is also conceivable that the second leather blank 2 comprises also multiple parts, which are connected to each other before or after covering the steering wheel rim. The covering of FIG. 4 can be of course used in the method according to the invention illustrated by means of FIGS. 1 to 3.

FIG. 5 shows an area of a first or a second blank 1, 2 for a steering wheel covering, respectively. The first blank 1 comprises in analogy to FIG. 4 multiple segments 1a, 1b in order to be able to arrange the covering in the area of a spoke (not shown) of the steering wheel.

The segments 1a, 1b comprise first edge sections 11a, 11b, respectively, which are connected to the first edge section 21 of the second blank 2 via a seam. The edge sections 11a, 11b, 21 continue in the blank not in a straight line, but at least sectionally curved in order to avoid crease formation of the covering after covering the steering wheel rim. Due to this design of the blanks 1, 2 a longitudinally extending covering, which can be arranged on the steering wheel rim, is obtained after connecting the two blanks 1, 2 along the edge sections 11a, 11b, 21.

Furthermore, the second blank 2 comprises a recess 211, which extends in the area of the spoke of the steering wheel after arranging the covering on the steering wheel rim. Accordingly, the segments 1a, 1b of the first blank 1 comprise also recesses 111a, 111b in this area.

After arranging the covering on the steering wheel rim the end sections 15a, 15b of the segments 1a, 1b located in the area of the spoke of the steering wheel can then be connected to each other. It is however also possible that the sections 15a, 15b are not connected to each other, but are only fixed on the steering wheel rim.

FIG. 6 shows also an area of a first or a second blank 1, 2, wherein the first blank comprises two segments 1a, 1b in analogy to FIG. 5. The blanks 1, 2 of FIG. 6 comprise somewhat different designed edge areas 11a, 11b or 21, wherein also recesses 111a′, 111b′ or 211′ are provided in order to be able to arrange the covering formed by the blanks 1, 2 in the area of a spoke of the steering wheel. However, the recesses are somewhat narrower and thus adapted to a narrower spoke of the steering wheel than the blanks of FIG. 5.

It is also conceivable that the areas of the blanks 1, 2 shown in FIG. 5 and FIG. 6 illustrate in each case only different areas of one and the same blank, i.e. a covering can comprise an area of blanks 1, 2 as shown in FIG. 5 as well as an area as shown in FIG. 6, wherein the covering is designed in the area of a broader spoke of the steering wheel as shown in FIG. 5 and in an area of one (or multiple) narrower spokes as shown in FIG. 6.

### LIST OF REFERENCE SIGNS

1 first leather blank
2 second leather blank
3 covering
4 seam
4a, 4b subsection
5 steering wheel rim
11 first edge section of a first leather blank
12, 22 end section
13 extension
13a, 13b sub area
14 second edge section of a first leather blank
14a, 14b sub area
15a, 15b edge section
21 first edge section of second leather blank
24 second edge section of second leather blank
111a′, 111b′, 211′ recess

1. A method for producing a steering wheel for a vehicle comprising the steps:
a) providing a steering wheel rim;
b) providing a first and second blank, in particular made of leather, for producing a covering of the steering wheel rim wherein the covering is visible after the steering wheel is completed;
c) producing the covering by connecting a first edge section of the first blank to a first edge section of the second blank via a seam; and
d) finally covering the steering wheel rim with a covering produced according to step c) such that the seam, which connects the first and the second blank to each other, continues essentially along an inner circumference of the steering wheel rim and is visible from the outside in the completed steering wheel.

2. The method according to claim 1, wherein before sewing according to step c) an edge of the first edge section of the first blank is brought into abutment with an edge of the first edge section of the second blank such that the first and the second edge section essentially do not overlap.

3. The method according to claim 1, wherein after covering according to step d) a second edge section of the first blank is connected to a second edge section of the second blank.

4. The method according to claim 3, wherein the second edge sections connected to each other continue essentially along the circumference of the steering wheel rim.

5. The method according to claim 3, wherein the steering wheel rim comprises a groove and both second edge sections are connected to each other by insertion into the groove or are inserted into the groove after they have been connected to each other via fixing means.

6. The method according to claim 5, wherein both second edge sections are glued to each other.

7. The method according to claim 5, wherein the steering wheel rim comprises a steering wheel rim skeleton and a foaming encompassing the steering wheel rim skeleton, wherein the groove is formed in the foaming.

8. The method according to claim 3, wherein both second edge sections are arranged overlapping or an edge of the second edge section of the first blank is brought into abutment with an edge of the second edge section of the second blank.

9. The method according to claim 1, wherein the steering wheel rim comprises a steering wheel rim skeleton and a foaming encompassing a steering wheel skeleton and the covering produced according to step c) is connected at least partially firmly bounded to the foaming.

10. The method according to claim 1, wherein the first and/or the second blank consists of multiple parts.

11. The method according to claim 1, wherein the seam, which connects the first and the second blank to each other, continues along an inner circumference of the steering wheel rim after covering according to step c).

12. The method according to claim 3, wherein the second edge seconds connected to each other continue after connecting such that they are arranged facing away from a driver in respect to the status of the steering wheel when assembled in the vehicle.

13. The method according to claim 3, wherein the seam, which connects the first and the second blank to each other, and the second edge sections connected to each other are arranged at least approximately at an angle of 90° if looked at in cross-section through the covered steering wheel rim.

14. The method according to claim 1, wherein a first end section and a second end section of the first and/or the second blank in each case are connected to each other such that an annular structure arises.

15. A covering for covering an steering wheel rim of the steering wheel for a vehicle comprising:
a first and a second blank, wherein a first edge section of the first blank is connected to a first edge section of the second blank via a seam such that the covering obtains a spatial design and the seam continues such that it continues after arranging the covering on the steering wheel rim along an inner circumference of the steering wheel rim, wherein
the first and the second blank comprise in each case a second circumferential free edge section, which continues after covering the steering wheel rim with the covering and in respect to the status of the steering wheel when assembled into the vehicle by facing away from a driver of a vehicle.

16. A method for producing a steering wheel for a vehicle comprising the steps:
a) providing a steering wheel rim;
b) providing a first and second blank, in particular made of leather, for producing a covering of the steering wheel rim wherein the covering is visible after the steering wheel is completed;
c) producing the covering by connecting a first edge section of the first blank to a first edge section of the second blank via a seam;
d) finally covering the steering wheel rim with a covering produced according to step c) such that the seam, which connects the first and the second blank to each other, continues essentially along an inner circumference of the steering wheel rim and is visible from the outside in the completed steering wheel; and
e) connecting a second edge section of the first blank to a second edge section of the second blank, wherein the steering wheel rim comprises a groove and both second edge sections are connected to each other by insertion into the groove or are inserted into the groove after they have been connected to each other via fixing means.
